(19) United States
(12) Patent Application Publication
(10) Pub. No.: US 2012/0072055 A1
(43) Pub. Date: Mar. 22, 2012

(54) Program Functions That Can Be Activated and Deactivated

(76) Inventors: Holger Barlsen, Langenhagen (DE); Rainer Risse, Pattensen-Reden (DE); Christian Schrader, Peine (DE); Axel Stender, Hameln (DE)

(21) Appl. No.: 13/266,926

(22) PCT Filed: Jan. 27, 2010
(86) PCT No.: PCT/EP2010/000459

§ 371 Date: Dec. 1, 2011

(30) Foreign Application Priority Data
May 22, 2009 (DE) 10 2009 022 362.2

(51) Int. Cl. G06F 17/00

(52) U.S. Cl. 701/2; 701/1

(57) ABSTRACT

The invention relates to an electronic control device for a vehicle, further to a system for activating program functions thereof, and to a corresponding method for the same. The invention allows subsequent activation, optionally at a cost, of program functions, particularly allowing commerce in such program functions. To this end, an electronic control device (2) for a vehicle (1) is provided, having an interface device for connecting to a data line (3), wherein the electronic control device comprises a plurality of program functions for performing control and regulating tasks in the vehicle, and at least a partial quantity of program functions can be deactivated, such that the electronic control device does not execute a deactivated program function, even if there is a corresponding need for control and regulating, wherein the electronic control device is set up for receiving and analyzing encoded activation information and, upon presentation of valid activation information, activates an associated program function that can be deactivated.

The invention generally relates to an electronic control device for a vehicle such as according to claim 1. The invention further relates to a method for activating program functions such as according to claim 10.

Electronic control devices of the general type under consideration are used in vehicles for executing control and regulation tasks. For example, such electronic control devices are known from antilocking systems, electronically controlled braking systems, automatic collision avoidance control systems or driving dynamics control systems. Such electronic control devices usually have a number of program functions. Some of the program functions are of greater importance for safe operation of the vehicle functions to be controlled or regulated than other functions, such as purely convenience functions for example.

It is also known for certain program functions of such electronic control devices to be designed so that they can be activated or deactivated with memory parameters. Thus, for example, program functions dependent on the vehicle equipment and configuration may be implemented in an electronic control device of standardized manufacture, but may be deactivated according to the vehicle type. In the area of commercial vehicles (trucks), for example, automatic control of a lifting axle is necessary for certain vehicles if the vehicle is correspondingly equipped with a lifting axle. For vehicles that are not equipped with a lifting axle, such a function is accordingly unnecessary. It is known for an electronic control device to be configured with certain memory parameters for the desired requirement.

Starting from this, it is an object of the invention to enable subsequent release of program functions, optionally at a cost, allowing commerce in such program functions.

This object is achieved by the electronic control device specified in claim 1 and the method according to claim 10. Advantageous embodiments are specified in the subclaims.

The invention, advantageously allows standardized electronic control devices to be produced that are suitable for a large number of variants of vehicles, and have all or at least most of the offered program functions in the program memory. By means of the embodiments of the invention, the desired program functions for a particular vehicle or a particular customer wish can also be released retrospectively, i.e., after production and sale of an electronic control device. The number of variants in the production of electronic control devices can thereby be kept low, thus reducing the costs for production and warehousing. With the inventive embodiments, a variant of the electronic control device can essentially be delivered to all customers. On the introduction of new program functions by the manufacturer, these functions are effectively always ready in the background for retrieval, but have to be released with an activation key. Such an electronic control device can then advantageously be configured for a precise match to the particular requirements.

The release of the program functions, i.e., the provision and transmission of activation information, can be executed, for example, by separate purchase of a license to a program function. Distribution of licenses or activation keys can advantageously be via electronic data carriers such as magnetic cards or smart cards (similarly to mobile phones) or via computer networks such as the Internet.

An advantageous application of the invention is in the area of electronic control devices for braking systems of commercial vehicles, i.e., trucks and trailers. Such vehicles have a wide range of product variants. Trailers in particular are distinguished by a large number of customer-specific applications that, with the invention, can be supplied efficiently with the desired program functions for controlling specific vehicle functions.

The electronic control device can advantageously be set up to receive an activation key from an operator unit installed in the vehicle. For example, the operator unit can be an onboard diagnostic device for setting vehicle functions and displaying error messages. Equally advantageously, the electronic control device can be set up to receive the activation key from an external diagnostic device which can be connected to the vehicle. The diagnostic device can also be designed as a commercial computer, for example a laptop, with special diagnostic software.

The necessary activation information for activating a program function is advantageously transmitted encrypted, in order to hinder unauthorized access to program functions or an unauthorized release of program functions. Known enciphering algorithms can be used for the encryption. The activation information can be generated centrally on a database server, for example, which performs license management for the program functions, or locally on the operator unit or diagnostic device. According to an advantageous embodiment of the invention, in the event that the generation of the activation key takes place locally on the operator unit or diagnostic device, this enquires of a central database for managing activation keys and licenses, whether a release with activation information is permitted. The operator unit or diagnostic device only generates the encrypted activation information if it receives a positive reply.

In the event that the generation of the activation information takes place at a remote location, this activation information can for example advantageously occur via a wireless data transfer or wired data transfer, for example over a computer network such as the Internet, to the operator unit, diagnostic device or the electronic control device. It is likewise advantageous to use a transportable data carrier such as a smart card or a magnetic card for the transfer. In this case, the operator unit or diagnostic device provided locally in the area of the vehicle is equipped with a suitable reading device for the data carrier.

According to an advantageous embodiment of the invention, a program function activated with valid activation information by the electronic control device is deactivated on reaching a preset intensity of usage of the program function, e.g., after a preset length of time, usage duration and/or frequency of use. Such a temporary activation of the program function, which can be deactivated, allows certain program functions to be supplied on a trial basis to a prospective customer. Advantageously, a sale of extensions of the usage entitlement is likewise possible for program functions that can be deactivated. Advantageously, the electronic control device has a memory for this, logs the length of time, usage duration and/or frequency of use of the program function, and stores this information in the memory. On reaching a preset threshold value, the electronic control device then deactivates the previously activated program function.

As criteria for the intensity of usage of a program function, the length of time, usage duration and/or frequency of use, for example, can advantageously be applied. The term length of time is understood here as the absolute time, measured by calendar date and time of day, or a period since the initial start-up of the electronic control device. The term “usage duration” refers to the respective duration of usage of a program function during the practical operation of the electronic control device. Correspondingly, the term “frequency of use” denotes the number of uses of a program function in the practical operation of the electronic control device. It is also possible to record the frequency of use per time unit as the intensity of usage.

According to another advantageous embodiment of the invention, the electronic control device is set up to activate a warning device, before the program function that was activated with valid activation information is deactivated. As a warning device, various devices in the vehicle are possible, which are observable by the vehicle driver, such as warning lights in the cockpit or acoustic signal generators. Advantageously, the electronic control device can also communicate with the operator unit installed in the vehicle, the operator unit then, for example, sending a warning message in the form of an SMS via a data channel to a mobile phone of the vehicle driver. The warning device thus allows the vehicle driver to be notified in good time that a currently available activated program function will soon be deactivated. The vehicle driver can then decide in good time whether to obtain an extension license for the program function.

According to a further advantageous embodiment of the invention, the set of program functions that can be deactivated has a subset of safety-related program functions. When driving conditions occur for the vehicle, which call for control or regulation by a safety-related program function, the necessary deactivated safety-related program function is activated at least for a time. This has the advantage that even safety-related program functions can be included in the licensing concept for the program functions, without jeopardizing road safety. The electronic control device thus always provides full and greatest safety, but only in such cases in which this is necessary because of the driving conditions from the road safety angle. In those cases in which the safety-related program functions would be desirable not for maintaining road safety, but purely to increase driving convenience, the electronic control device therefore does not provide the unlicensed deactivated program function. An example of such a safety-related program function, which also has a convenience aspect, is a synchronization of braking forces between towing vehicle and trailer, for example.

According to another advantageous embodiment of the invention, the electronic control device is set up to store the activation frequency and/or the duration of activation of the previously mentioned safety-related program function, which is deactivated, but activated at times because of driving conditions. The stored data can advantageously be used for a statistical evaluation, for example. In the case of relatively frequent statistical average activation of a certain safety-related program function because of driving conditions, a recommendation can be given to a vehicle manufacturer or a freight carrier, for example, to equip his vehicles generally with such a safety-related program function, which is permanently activated. The storage of the activation frequency and duration of activation advantageously also allows further business uses of this data, such as usage-based license fee models.

An embodiment of a method for activating program functions in an electronic control device for a vehicle has an electronic control device with a plurality of program functions for executing control and regulation tasks in the vehicle, it being possible to deactivate at least a subset of the program functions in such a way that the electronic control device does not execute a deactivated program function even if there is a need of corresponding control and regulation, it being possible to supply encrypted activation information to the electronic control device, the electronic control device decrypting the encrypted activation information and in case of valid activation information, activating a related deactivated program function.

An embodiment of a system for activating program functions in an electronic control device advantageously has a database for managing activation keys for activating program functions in the electronic control device. The database advantageously also has license information, i.e., information about who has purchased a license, with what scope and for which program function. This enables the database to provide information about a permissible activation of program functions, and to answer corresponding queries on license information and/or activation keys.

It is likewise advantageous to connect the database via a database server to a computer network such as the Internet, for example. The database server can then transfer activation keys wirelessly or by wire to the electronic control device, possibly via the operator unit installed in the vehicle or a diagnostic device which can be connected to the vehicle.

The invention will be further described in detail with reference to an exemplary embodiment, making use of a drawing.

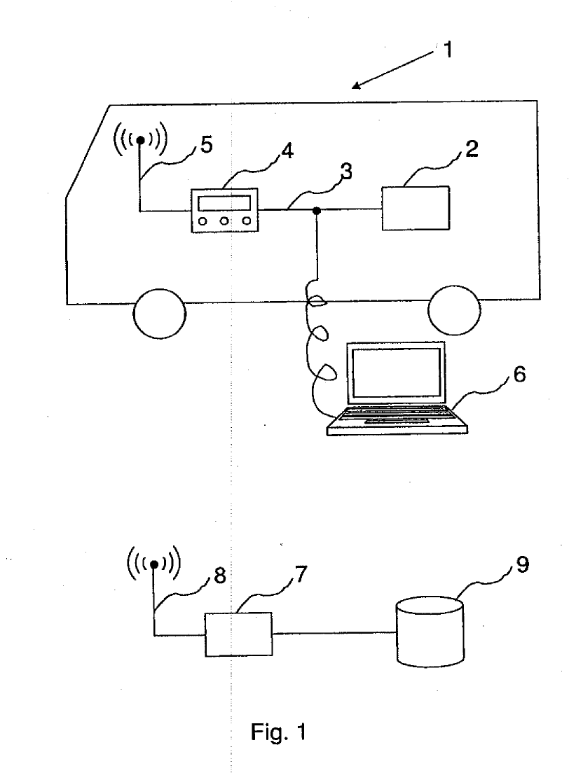

FIG. 1 shows a vehicle 1 with an electronic control device 2 provided in it. The electronic control device 2 controls various functions in the vehicle such as the braking system, a pneumatic level adjustment and a lifting axle. For this purpose, the control device 2 is connected to corresponding sensors and actuators, which are known to this extent and are therefore not shown in detail in FIG. 1.

The electronic control device 2 is connected via a data line 3 to an operator unit 4. The data line 3 can be designed, for example, as a serial bus system, as a CAN bus for example. The operator unit 4 represents a control unit provided in the vehicle for selecting various vehicle functions. For this purpose, the operator unit 4 has a display and a plurality of buttons. Advice, warning or error messages, for example, can also be shown on the display of the operator unit 4. The operator unit 4 is equipped with a wireless interface 5, which for simplification is shown in FIG. 1 in the form of an antenna. The operator unit 4 and also the electronic control device 2 can communicate over the interface 5 with other remote devices. A connector for connecting an external diagnostic device 6 to the data line 3 is further provided in the vehicle 1. By means of the diagnostic device 6, settings can be selected on the electronic control device, or stored values can be read from the control device 2. For example, the usage duration and/or the frequency of use of program functions can be retrieved and displayed using the operator unit 4 or the diagnostic device 6.

FIG. 1 also shows a database 9, which is connected to a database server 7. The database server 7 is likewise connected to a wireless interface 8, which is likewise shown in FIG. 1 as an antenna for simplification. The database 9, database server 7 and interface 8 are for example arranged at a central administrative point remote from the vehicle 1, at which central administrative point the licenses for the program functions are managed.

The invention allows the electronic control device 2 to be equipped initially during production with a large number of program functions in the program memory. All program functions that are not necessarily available for each customer or application are then designated as license functions. License functions are program functions that can be deactivated, and which are initially deactivated when the electronic control device is delivered after manufacture. During start-up of the electronic control device at a vehicle manufacturer or in a workshop, license information for the relevant program function is requested from the electronic control device 2 if activation of a particular deactivated program function is desired. The diagnostic device 6 or operator unit 4 then enquires about a valid license for the program function in the database server 7 via a data connection, for example via the interface 5 or 8 or via an Internet connection. The database server 7 checks in the database 9 whether a license is available. If the license is available, the database server 7 transmits an encrypted activation information item or other license information to the operator unit 4 or the diagnostic device 6. If the encrypted activation information is transmitted at once, it is then made available to the electronic control device 2. In the event of other information from the database server 7, which shows the availability of a license, the operator unit 4 or the diagnostic device 6 then determines the encrypted activation information and sends this to the electronic control device 2. The electronic control device 2 checks the encrypted activation information. If a valid activation information item is detected as a result, the electronic control device activates the requested program function.

It is also advantageously possible to configure the electronic control device in the factory during manufacture, in such a way that even the program functions that can be deactivated, or at least part of these, are initially delivered to the customer in an activated state. In this case, it is advantageous to set a time limit for the validity of the activation information, e.g., with a preset length of time, usage duration and/or frequency of use for the program function. After the preset length of time, usage duration and/or frequency of use is reached, the electronic control device then deactivates the program function independently.

1. An electronic control device (2) for a vehicle (1) having an interface facility for connection to a data line (3), the electronic control device including a plurality of program functions for executing control and regulation tasks in the vehicle, and it being possible to deactivate at least a subset of the program functions such that the electronic control device does not execute a deactivated program function even when there is a need of corresponding control and regulation, the electronic control device being configured to receive and evaluate encrypted activation information, and a related program function, which can be deactivated, being activated on valid activation information.

2. The electronic control device according to claim 1, characterized in that a program function activated with a valid activation information item is deactivated by the electronic control device (2) when a preset intensity of usage is reached for the program function.

3. The electronic control device according to claim 2, characterized in that the intensity of usage is recorded as the length of time, the usage duration, the frequency of use and/or frequency of use per time unit for the program function.

4. The electronic control device according to claim 2 or 3, characterized in that the electronic control device (2) is configured to activate a warning device, before the program function that was activated with valid activation information is deactivated.

5. The electronic control device according to at least one of the preceding claims, characterized in that the electronic control device (2) is configured to receive an activation key from an operator unit (4) installed in the vehicle (1) or from an external diagnostic device (6) that is connectable to the vehicle (1).

6. The electronic control device according to at least one of the preceding claims, characterized in that the electronic control device (2) is configured to receive an activation key transmitted via a wireless data connection.

7. The electronic control device according to at least one of the preceding claims, characterized in that the set of program functions that can be deactivated has a subset of safety-related program functions, the necessary deactivated safety-related program function being activated at least for a time when driving conditions occur for the vehicle (1) that call for control or regulation by a safety-related program function.

8. The electronic control device according to claim 7, characterized in that the electronic control device (2) is configured to store the activation frequency and/or duration of activation of safety-related program functions that are deactivated, but activated at times because of driving conditions.

9. The electronic control device according to at least one of the preceding claims, characterized in that the electronic control device (2) is configured to control a braking system of the vehicle (1).

10. A method for activating program functions in an electronic control device for a vehicle, the electronic control device having a plurality of program functions for executing control and regulation tasks in the vehicle, it being possible to deactivate at least a subset of the program functions such that the electronic control device does not execute a deactivated program function even when there is a need of corresponding control and regulation, it being possible to supply encrypted activation information to the electronic control device, the electronic control device decrypting the encrypted activation information and on valid activation information, activating a related deactivated program function.

11. The method according to claim 10, characterized in that the electronic control device receives the encrypted activation key from an operator unit (4) installed in the vehicle (1) or from an external diagnostic device (6) that is connectable to the vehicle (1).

12. The method according to claim 10 or 11, characterized in that the electronic control device (2) receives the activation key via a wireless data connection.

13. A system for activating program functions in an electronic control device (2) according to one of the preceding claims, with a database (9) for managing license information and/or activation keys for activating program functions in the electronic control device (2).

14. The system according to claim 13, characterized in that the database (9) is connected to a database server (7), which manages the database (9), the database server (7) being configured to transfer activation keys to the electronic control device (2).

15. The system according to claim 14, characterized in that the database server (7) transmits the activation key via a wireless data connection (8).
